(19) United States
(12) Patent Application Publication
(10) Pub. No.: US 2007/0011359 A1
(43) Pub. Date: Jan. 11, 2007

(54) MULTI-CLASS DATA TRANSMISSION APPARATUS AND RELATED METHOD THEREOF

(76) Inventors: Jin-Ru Chen, Tai-Chung City (TW); Chun-Feng Liu, Taipei City (TW); Yung-Chieh Lo, Miao-Li City (TW)

Correspondence Address: NORTH AMERICA INTELLECTUAL PROPERTY CORPORATION, P.O. BOX 506, MERRIFIELD, VA, 22116, US

(21) Appl. No.: 11/421,483

(22) Filed: Jun. 1, 2006

(30) Foreign Application Priority Data
Jun. 1, 2005 (TW) 094117997

(51) Int. Cl. G06F 15/16

(52) U.S. Cl. 709/251

(57) ABSTRACT

A multi-class data transmission apparatus includes a first physical port having a first receiving buffer for receiving a packet, a second physical port, a third physical port, and an access control module. The second physical port includes a second high-priority transferring buffer, a second low-priority transferring buffer, and a second receiving buffer for receiving data from the second high/low-priority transferring buffers. The third physical port includes a third high-priority transferring buffer and a third low-priority transferring buffer. The access control module is utilized to read the packet from the first receiving buffer in order to directly transfer the packet, or output the packet through the second physical port to the third physical port according to a packet type.

### BACKGROUND OF THE INVENTION

1. Field of the Invention

The invention relates to a data transmission apparatus, and more particularly, to a multi-class data transmission apparatus having a plurality of predetermined priorities and related method thereof.

2. Description of the Prior Art

In computer network transmission fields, many kinds of packets need to be processed. However, the current integrated circuit (IC) only supports two-class quality of service (QoS) queues in each physical port for switch application. Please refer to FIG. 1, which is a diagram of a switch 100 according to the prior art. Please note that for the purposes of simple illustration, FIG. 1 only shows two physical ports 110 and 120 in the switch 100. As shown in FIG. 1, the switch 100 comprises the two physical ports 110 and 120, and an access controlling module 130 coupled to the physical ports 110 and 120. The physical ports 110 and 120 both comprise a transferring buffer 140 corresponding to a high transmission priority, a transferring buffer 150 corresponding to a low transmission priority, and a receiving buffer 160. Furthermore, the access controlling module 130 comprises a storage device 170 for storing an access control list (ACL) 180, and an access controller 190. The above-mentioned transferring buffer 150 and the receiving buffer 160 transfer packets sequentially by queue.

In addition, the above-mentioned access control list stores the transmission priorities corresponding to different kinds of packets. Therefore, when a packet is received through the receiving buffer 160 of the physical port 110 (i.e. the switch 100 receives the packet), the access controlling module 130 determines a priority of the packet according to the access control list 180 stored inside the access controlling module 130. Furthermore, the access controlling module 130 utilizes the access controller 190 to transfer the packet to the transferring buffer 140 or 150 according to the priority of the packet. For example, if the packet is a real-time transport protocol (RTP) packet, which often has a high priority, the access controlling module 130 transfers the RTP packet to the high priority transferring buffer 140 such that the RTP packet can be ensured to be outputted rapidly.

Unfortunately, because of the progress of computer network transmission technology, the switch supporting only two-class QoS queues cannot meet current users' demands. This is because in actual utilization has many kinds of packets, besides the above-mentioned RTP packet, transferred in the computer network, such as a hypertext transfer protocol (HTTP) packet, a file transport protocol (FTP) packet, or a peer-to-peer (P2P) packet. In order to provide better QoS, these different kinds of packets have to correspond to different priorities. Evidently, the prior art switch 100 cannot provide this function.

### SUMMARY OF THE INVENTION

It is therefore one of the primary objectives of the claimed invention to provide a multi-class data transmission apparatus and related method thereof, to solve the above-mentioned problem.

According to an exemplary embodiment of the claimed invention, a multi-class data transmission apparatus is disclosed. The data transmission apparatus comprises: a first physical port; a second physical port; a third physical port; and an access controlling module coupled to the first, the second, and the third physical ports for reading a packet from a first receiving buffer of the first physical port, and for directly outputting the packet to the third physical port or outputting the packet through the second physical port to the third physical port according to the packet type; wherein the first physical port comprises a first receiving buffer for receiving the packet, the second physical port comprises a second high priority transmission buffer, a second low priority transmission buffer, and a second receiving buffer for receiving data transferred by the second high priority transmission buffer and the second low priority transmission buffer, and the third physical port comprises a third high priority transmission buffer and a third low priority transmission buffer. A transmission priority of the second high priority transmission buffer is higher than that of the second low priority transmission buffer. A transmission priority of the third high priority transmission buffer is higher than that of the third low priority transmission buffer.

According to another exemplary embodiment of the claimed invention, a multi-class data transmission apparatus for receiving and outputting a packet is disclosed. The multi-class data transmission apparatus comprises: n physical ports comprising at least one input port and at least one output port, wherein the input port and the output port are respectively utilized to receive and output the packet, and n is an integer larger than 2; and an access controlling module, coupled to the n physical ports, for reading the packet from the input port, and for directly transferring the packet to the output port in order to output the packet, or for transferring the packet to the output port through the input port and other physical ports except the output port in order to output the packet according to the packet type.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a switch according to the prior art.

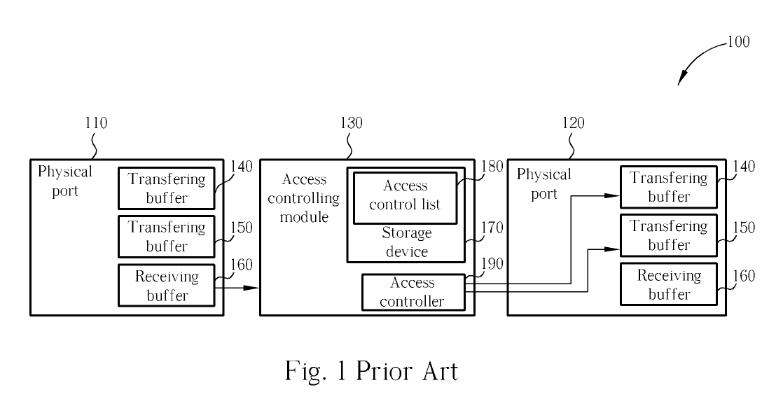

FIG. 2 is a diagram of a switch of a first embodiment according to the present invention.

FIG. 3 is a diagram of a switch of a second embodiment according to the present invention.

### DETAILED DESCRIPTION

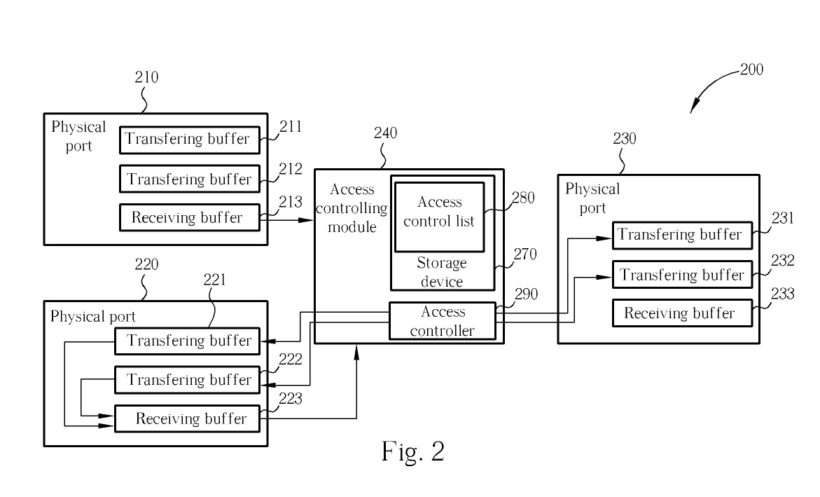

Please refer to FIG. 2, which is a diagram of a switch 200 of a first embodiment according to the present invention. As shown in FIG. 2, the switch 200 comprises three physical ports 210, 220, and 230, and an access controlling module 240 coupled to the physical ports 210, 220, and 230. The physical ports 210, 220, and 230 respectively comprise transferring buffers 211, 221, and 231 corresponding to a high transmission priority, transferring buffers 212, 222, and 232 corresponding to a low transmission priority, and receiving buffers 213, 223, and 233. The access controlling module 240 comprises a storage device 270 for storing an access control list (ACL) 280, and an access controller 290. Please note that in this embodiment, the above-mentioned transferring buffers 211, 221, 231, 212, 222, and 232 and the receiving buffers 213, 223, and 233 all transfer data sequentially by queue.

In the switch 200, the receiving buffer 223 of the physical port 220 is coupled to the transferring buffer 221 and 222 of the physical port 220. Therefore, the packets outputted by the transferring buffers 221 and 222 come back to the receiving buffer 223. The detailed operations of the switch 200 are illustrated in the following disclosure.

In the following disclosure, we assume that all packets are only divided into three different transmission priorities. For example, the RTP packet can be predetermined as a highest priority, the HTTP packet can be predetermined as an inferior priority, and the FTP packet can be predetermined as a lowest priority. In addition, the relationship between the packets and the priorities are firstly stored in the access control list 280.

Therefore, when the switch 200 receives the RTP packet, the access controller 290 determines that the RTP packet is a highest priority packet according to the access control list 280, and then directly transfers the RTP packet to the transferring buffer 231 of the physical port 230, such that the RTP packet can be outputted through the transferring buffer 231. Because the transferring buffer 231 has a higher priority than the transferring buffer 232, the RTP packet is outputted in a highest priority (that is, the RTP packet is outputted in fastest).

On the other hand, when the switch 200 receives the HTTP packet, the access controller 290 determines that the HTTP packet is an inferior priority packet according to the data stored in the access control list 280. Therefore, the access controller 290 transfers the HTTP packet to the transferring buffer 221 of the physical port 220. Because the receiving buffer 223 is coupled to the transferring buffer 221, the receiving buffer 223 then receives the HTTP packet and transfers the packet back to the access controlling module 240. After the access controlling module 240 receives the HTTP packet from the physical port 220, the access controlling module 240 directly transmits the HTTP packet to the transferring buffer 232 of the physical port 230 in order to utilize the transferring buffer 232 to output the HTTP packet. As the transferring buffer 232 has a lower priority than the transferring buffer 231, the HTTP packet has a lower priority than the above-mentioned RTP packet. In other words, the switch 200 outputs the HTTP packet after the RTP packet has been completely outputted.

Furthermore, when the switch 200 receives the FTP packet, the access controller 290 determines that the FTP packet is a lowest priority packet according to the data stored in the access control list 280. Therefore, the access controller 290 transfers the FTP packet to the transferring buffer 222 of the physical port 220. Because the receiving buffer 223 is coupled to transferring buffer 222, the receiving buffer 223 receives the FTP packet and transmits the FTP packet back to the access controlling module 240. After the access controlling module 240 receives the FTP packet of the physical port 220, the access controlling module 240 directly transmits the FTP packet to the transferring buffer 232 of the physical port 230 in order to utilize the transferring buffer 232 to output the FTP packet. Because the transferring buffer 222 has a lower priority than the transferring buffer 221, the FTP packet has a lower priority than the above-mentioned HTTP packet. Therefore, after the transferring buffer 221 transfers the HTTP packet to the receiving buffer 223 in order to further transfer the HTTP packet to the transferring buffer 232 to output the HTTP packet, the transferring buffer 222 outputs the FTP packet to the receiving buffer 223 in order to transfer the FTP packet to the transferring buffer 232 to output the FTP packet. In other words, the switch 200 outputs the FTP packet when the RTP packet and the HTTP packet are outputted completely.

On the other hand, the switch 200 can be also operated as illustrated by the following disclosure, in order to achieve the same effect.

When the switch 200 receives the RTP packet, the access controller 290 determines that the RTP packet is a highest priority packet according to the data stored in the access control list 280. Therefore, the access controller 290 directly transfers the RTP packet to the transferring buffer 221 of the physical port 220. Because the receiving buffer 223 is coupled to the transferring buffer 221, the receiving buffer 223 receives the RTP packet, and transfers the RTP packet back to the access controlling module 240. After receiving the RTP packet from the physical port 220, the access controlling module 240 directly transmits the RTP packet to the transferring buffer 231 of the physical port 230 in order to utilize the transferring buffer 231 to output the RTP packet. Because the transferring buffer 221 has a higher transmission priority than the transferring buffer 222 and the transferring buffer 231 has a higher transmission priority than the transferring buffer 232, the RTP packet has the highest priority.

On the other hand, when the switch 200 receives the HTTP packet, the access controller 290 determines that the HTTP packet is an inferior priority packet according to the data stored in the access control list. Therefore, the access controller 290 transfers the HTTP packet to the transferring buffer 222 of the physical port 220. Because the receiving buffer 223 is coupled to the transferring buffer 222, the receiving buffer 223 receives the HTTP packet and transfers the HTTP packet back to the access controlling module 240. After receiving the HTTP packet from the physical port 220, the access controlling module 240 directly transfers the HTTP packet to the transferring buffer 231 of the physical port 230 in order to utilize the transferring buffer 231 to output the HTTP packet. As the transferring buffer 222 has a lower priority than the transferring buffer 221, the HTTP packet has a lower priority than the above-mentioned RTP packet. In other words, the switch 200 outputs the HTTP packet when the RTP packet is completely outputted.

Furthermore, when the switch 200 receives the FTP packet, the access controller 290 determines that the FTP packet is a lowest priority packet according to the data stored in the access control list 280. Therefore, the access controller 290 transfers the FTP packet to the transferring buffer 232 of the physical port 230 in order to utilize the transferring buffer 232 to output the FTP packet. As the transferring buffer 232 has a lower priority than the transferring buffer 231 and the above-mentioned RTP and HTTP packets are both outputted through the transferring buffer 231, the FTP packet has the lowest priority. In other words, the switch 200 outputs the FTP packet when the RTP packet and the HTTP packet are outputted completely.

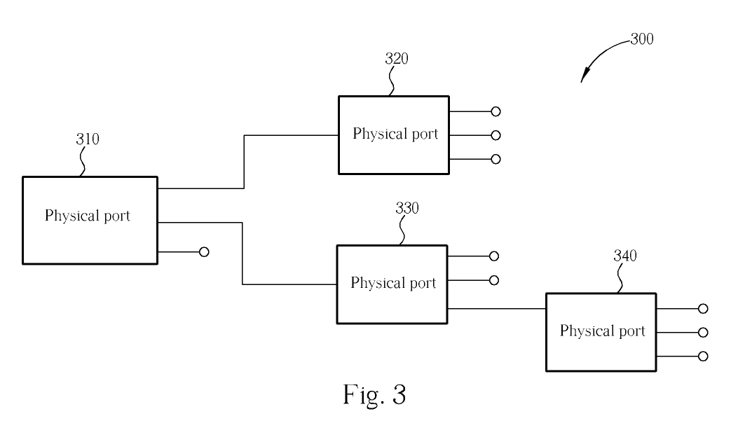

Please note that the present invention can support more priorities of data transmission. The above-mentioned three different priorities are only utilized as an embodiment, not a limitation. For example, if each physical port is able to support m-class data transmission, serial coupling n physical ports through using the present invention method can support m*n−(n−1) class data transmission. Please refer to FIG. 3, which is a diagram of a switch 300 of a second embodiment according to the present invention. As shown in FIG. 3, the switch 300 comprises 4 physical ports 310, 320, 330, and 340 (i.e. n=4) In addition, each physical port is able to support three-class QoS queue transmission (i.e. m=3) the connection shown in FIG. 3 is then able to support 9-class data transmission. Here, further changes and utilizations of the present invention should be known by those skilled in the art, and are thus omitted here.

In addition, the present invention is not limited to be utilized in a switch. In other words, any other network devices (e.g. routers or hubs) having physical ports and supporting multi-class queue transmission can support more classes of data transmission by coupling the inner circuit as the concepts of the present invention. This also belongs to the spirit of the present invention.

Please note that the present invention is not limited to be utilized to process the above-mentioned FTP, HTTP, and RTP packets and other kinds of packets can be processed through using the concepts of the present invention. For example, the present invention can support a peer-to-peer (P2P) packet.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A multi-class data transmission apparatus, comprising:
a first physical port, comprising a first receiving buffer for receiving a packet;
a second physical port, comprising:
a second high-priority transmission buffer;
a second low-priority transmission buffer; and
a second receiving buffer for receiving data transferred by the second high-priority transmission buffer and the second low-priority transmission buffer, wherein a transmission priority of the second high-priority transmission buffer is higher than that of the second low-priority transmission buffer;
a third physical port comprising:
a third high-priority transmission buffer; and
a third low-priority transmission buffer, wherein a transmission priority of the third high-priority transmission buffer is higher than that of the third low-priority transmission buffer; and
an access controlling module, coupled to the first, the second, and the third physical ports, for reading the packet from the first receiving buffer, and for directly outputting the packet to the third physical port or outputting the packet through the second physical port to the third physical port according to a packet type.

2. The multi-class data transmission apparatus of claim 1, wherein
when the packet type corresponds to a first priority, the access controlling module transfers the packet to the third high-priority transmission buffer for outputting the packet;
when the packet type corresponds to a second priority, the packet is transferred orderly through the second high-priority transmission buffer, the second receiving buffer, and the access controlling module to the third low-priority transmission buffer for outputting the packet; and
when the packet type corresponds to a third priority, the packet is transferred orderly transferred through the second low-priority transmission buffer, the second receiving buffer, and the access controlling module to the third low-priority transmission buffer for outputting the packet.

3. The multi-class data transmission apparatus of claim 1, wherein
when the packet type corresponds to a first priority, the packet is transferred orderly through the second high-priority transmission buffer, the second receiving buffer, and the access controlling module to the third high-priority transmission buffer for outputting the packet;
when the packet type corresponds to a second priority, the packet is transferred orderly through the second low-priority transmission buffer, the second receiving buffer, and the access controlling module to the third high-priority transmission buffer for outputting the packet; and
when the packet type corresponds to a third priority, the access controlling module transfers the packet to the third low-priority transmission buffer for outputting the packet.

4. The multi-class data transmission apparatus of claim 1, wherein each transmission buffer and each receiving buffer access data in a queue.

5. The multi-class data transmission apparatus of claim 1, wherein the packet is a real-time transport protocol (RTP) packet, a hypertext transfer protocol (HTTP) packet, a file transport protocol (FTP) packet, a peer-to-peer (P2P) packet, or other network packets.

6. The multi-class data transmission apparatus of claim 1 being utilized in a switch, a router, a hub, or other network devices.

7. The multi-class data transmission apparatus of claim 1, wherein the access controlling module comprises:
a storage unit for storing an access control list (ACL), the access control list stores a predetermined priority relationship corresponding to the packet type; and
an access controller, coupled to the storage unit, for transferring the packet according to the predetermined priority relationship.

8. A multi-class data transmission apparatus for receiving and outputting a packet, comprising:
n physical ports comprising at least one input port and at least one output port, wherein the input port and the output port are respectively utilized to receive and output the packet, and n is an integer larger than 2; and
an access controlling module, coupled to the n physical ports, for reading the packet from the input port, and for transferring the packet to the output port to output the packet, or transferring the packet to the output port through the input port and the other physical ports except the output port to output the packet according to a packet type.

9. The multi-class data transmission apparatus of claim 8, wherein each physical port supports m data transmission priorities, the multi-class transmission apparatus supports m*n−(n−1) data transmission priorities, and m is an integer larger than 1.

10. The multi-class data transmission apparatus of claim 8, wherein at least one of the other physical ports except the input port and the output port comprises:
a high-priority transmission buffer;
a low-priority transmission buffer; and
a receiving buffer for receiving data transferred by the high-priority transmission buffer and the low-priority transmission buffer, wherein a transmission priority of the high-priority transmission buffer is higher than that of the low-priority transmission buffer.

11. The multi-class data transmission apparatus of claim 8, wherein each transmission buffer and each receiving buffer access data in a queue.

12. The multi-class data transmission apparatus of claim 8, wherein the packet is a real-time transport protocol (RTP) packet, a hypertext transfer protocol (HTTP) packet, a file transport protocol (FTP) packet, a peer-to-peer (P2P) packet, or other network packets.

13. The multi-class data transmission apparatus of claim 8 being utilized in a switch, a router, a hub, or other network devices.

14. The multi-class data transmission apparatus of claim 8, wherein the access controlling module comprises:
a storage unit for storing an access control list (ACL), the access control list stores a predetermined priority relationship corresponding to the packet type; and
an access controller, coupled to the storage unit, for transferring the packet according to the predetermined priority relationship.

15. A network data transmission method, comprising:
receiving a packet from a first physical port;
determining the transmission priority of the packet according to a list;
transmitting the packet to a second physical port;
receiving the packet from the second physical port; and
transmitting the packet to a third physical port for outputting the packet.

16. The method of claim 11, wherein the list is an access control list (ACL) for storing the priority relationship corresponding to the packet.

17. The method of claim 11, wherein the packet is a real-time transport protocol (RTP) packet, a hypertext transfer protocol (HTTP) packet, a file transport protocol (FTP) packet, a peer-to-peer (P2P) packet, or other network packets.

18. The method of claim 11 being utilized in a switch, a router, a hub, or other network devices.
